(19) United States
(12) Patent Application Publication
(10) Pub. No.: US 2013/0215039 A1
(43) Pub. Date: Aug. 22, 2013

(54) PROMPTING DEVICE FOR OPTICAL FINGER NAVIGATION SENSOR, PROMPTING METHOD THEREOF AND PROMPTING SYSTEM

(71) Applicants: YING-CHIEH YU, New Taipei (TW); Kuang-sheng Tsai, New Taipei (TW); Meng-ching Cho, New Taipei (TW); You-ruei Lin, New Taipei (TW)

(72) Inventors: YING-CHIEH YU, New Taipei (TW); Kuang-sheng Tsai, New Taipei (TW); Meng-ching Cho, New Taipei (TW); You-ruei Lin, New Taipei (TW)

(73) Assignee: Cheng Uei Precision Industry Co., LTD., New Taipei City (TW)

(21) Appl. No.: 13/398,836

(22) Filed: Feb. 16, 2012

(51) Int. Cl. G08B 5/36; G06F 3/041

(52) U.S. Cl. 345/173

(57) ABSTRACT

A prompting device for an optical finger navigation sensor, a prompting method thereof, and a prompting system are provided. The prompting device includes at least one light-emitting unit, which is disposed around the OFN sensor. The prompting device is integrated with the OFN sensor. According to the finger position transmitted back to the operating system from the OFN sensor and the action that the operation system can do accordingly, the light-emitting unit provides a blue or green optical indication for the user to perform the next action. Or when the operation system performs the action needed to prompt, the prompting device can prompt the user for the next action. Therefore, the optical indication of the present invention can prompt the user to perform the action, thereby providing a convenience for the user.

### BACKGROUND OF THE INVENTION

1. Field of the Invention

The present invention relates to a prompting device and a prompting method thereof, and more particularly to a prompting device for an optical finger navigation sensor, a prompting method thereof and a prompting system.

2. Description of the Prior Art

An optical finger navigation (OFN) sensor is a derivative product of an optical mouse. The principle of the OFN sensor is that: the infrared light emitted by an infrared LED (Light Emitting Diode) is refracted by a prism and then passes through an infrared filter to a user's finger, then the infrared light can be reflected by the finger to pass through the optical lens to arrive at a sensor to form an image, and a special DSP (Digital Signal Microprocessor) is used to analyze the difference between the images output at different time thereby for judging the moving direction and the moving distance and determining the finger position.

The OFN may be applied to a keypad and a QWERTY keyboard of a mobile phone. The function of the OFN sensor is similar to a red button of the IBM and Toshiba notebooks, which has a touch function and may be controlled to select by one single finger. Because the OFN sensor has many features of high positioning precision, a light and thin module, the operating habit of being similar to the prior mouse and so on. The application scope of the OFN sensor is gradually expanded to the relative products, such as a smart phone, a MP4/MP3, a MID (Mobile Internet Device), a remote controller, a laptop computer and so on.

However, there is no any prompt when the prior OFN sensor is in use. For the user who is not familiar with the operating characteristic, to use in the initial will often encounter many difficulties. If the OFN sensor can provide some necessary message to prompt the user, this will provide a huge convenience for the user. But now, such products still do not appear in market.

### BRIEF SUMMARY OF THE INVENTION

An object of the present invention is to provide a prompting device for an optical finger navigation sensor, a prompting method thereof and a prompting system for solving above problems.

To achieve the above object, in accordance with the present invention, a prompting device for an optical finger navigation sensor is provided, comprising at least one light-emitting unit. The light-emitting unit is disposed around the optical finger navigation sensor.

Preferably, the light-emitting unit is annular and surrounds the optical finger navigation sensor.

Preferably, the quantity of the light-emitting unit is two, which are respectively disposed on two sides of the optical finger navigation sensor.

Preferably, the light-emitting unit is a blue light source or a green light source.

To achieve the above object, in accordance with the present invention, a prompting method of a prompting device for an optical finger navigation sensor is also provided, comprising the following steps of:

1) employing an operating system to send out an order signal according to a task of being currently performed;

2) determining by the operating system whether to need to prompt a user for the order signal, and if need to prompt, performing a step of 3);

3) emitting out an indication light by the prompting device according to the order signal;

4) judging whether the user performs an action, and if the optical finger navigation sensor senses that the user performs the action in a predetermined time, performing a step of 5); and

5) reporting the performing position and the performed action and transmitting these messages back to the operating system by the optical finger navigation sensor.

In the step of 2), if the operating system determines that the user need not be prompted for the order signal, the prompting device of the optical finger navigation sensor will not prompt the user.

In the step of 4), if the optical finger navigation sensor does not sense that the user performs the action in the predetermined time, the optical finger navigation sensor will report the message of no action being performed by the user to the operating system.

To achieve the above object, in accordance with the present invention, a prompting system is further provided, comprising:

an operating system sending out an order signal according to a task of being currently performed and determining whether to need to prompt a user for the order signal;

a prompting device emitting out an indication light according to the order signal; and

an optical finger navigation sensor sensing that the user performs an action, reporting the performing position and the performed action and transmitting these messages back to the operating system.

Based on the above description, the prompting device of the present invention employs the light-emitting unit to be disposed around the optical finger navigation sensor. The optical indication of the light-emitting unit can prompt the user to perform the next action, thereby providing a convenience for the user.

For more clearly and easily understanding above object or other objects, the feather and the advantage of the present invention, the following text will take a preferred embodiment of the present invention with reference to the accompanying drawings for detail description as follows.

### BRIEF DESCRIPTION OF THE DRAWINGS

FIG. 1 is a schematic view of a first embodiment of a prompting device for an OFN sensor in the present invention.

FIG. 2 is a schematic view of a first embodiment of a prompting device for an OFN sensor in the present invention.

FIG. 3 is a schematic view of a first embodiment of a prompting device for an OFN sensor in the present invention.

FIG. 4 is a schematic view of a first embodiment of a prompting device for an OFN sensor in the present invention.

FIG. 5 is a flowchart of a prompting method of a prompting device for an OFN sensor in the present invention.

FIG. 6 is a block diagram of an electrical device adopted a prompting device for an OFN sensor and a graphic interface in the present invention.

### DETAILED DESCRIPTION OF THE PREFERRED EMBODIMENTS

The following embodiment with reference to the accompanying drawings now has been given for detail describing the technology, the feature, the object and the effect of the present invention.

Please refer to FIGS. 1 to 4 and FIG. 6, which are different embodiments of a prompting device for an optical finger navigation (OFN) sensor 1 in the present invention, the prompting device comprises one or a plurality of light-emitting units 2 disposed around a periphery thereof. The light-emitting state is controlled by an electrical device equipped with the OFN sensor 1. Generally, the electrical device with the OFN sensor 1, such as a palmtop mobile internet device, adopts a graphic interface 4 to provide a cursor for a user to select and perform a task. The user can slightly move his finger on the OFN sensor 1 to move the cursor of the graphic interface 4. When the cursor of the graphic interface 4 stays at a specific position, such as a system button representing enter or cancel, a button representing the internet connection and other buttons representing the orders needed to be performed, the light-emitting unit 2 will receive the order from the electrical device to start to continuously or discontinuously emit light thereby providing the indication of clicking or continuously clicking the OFN sensor 1 for the user.

The above light-emitting unit 2 preferably adopts a blue light source or a green light source. Of course, the light-emitting unit 2 also may adopt other light source, such as a red light source or a yellow light source, according to the actual demand of the user. In the present invention, the electrical device can supply the power to the light-emitting unit 2, and can control the working state of the light-emitting unit 2. The electrical circuit of the light-emitting unit 2 can be designed by the person of ordinary skill in the art, so it need not be specifically described here.

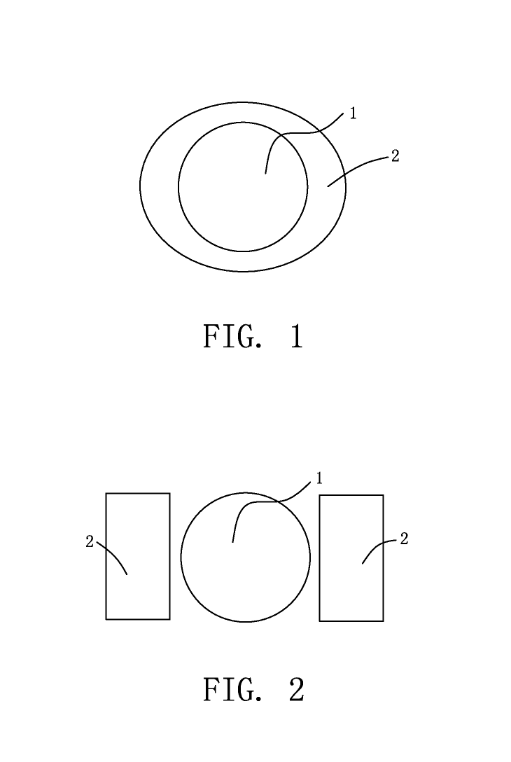

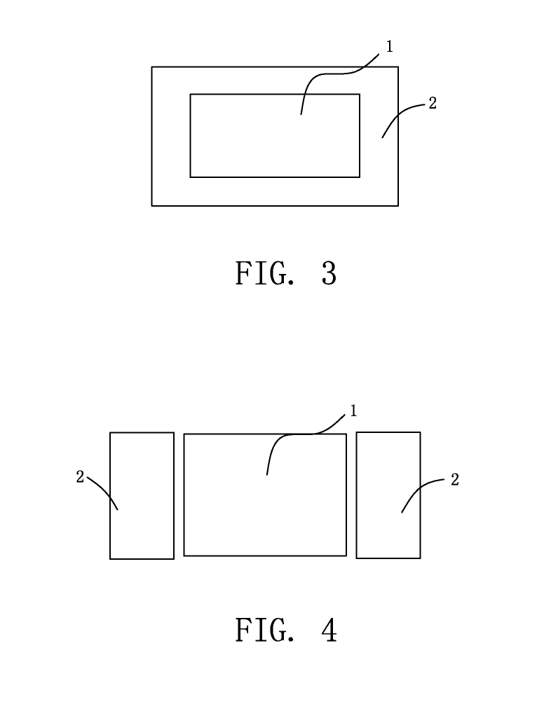

FIGS. 1 to 4 show different embodiments of the prompting device for the optical finger navigation (OFN) sensor 1 in the present invention. In a first embodiment shown in FIG. 1, the light-emitting unit 2 is annular and surrounds the OFN sensor 1. In a second embodiment shown in FIG. 2, the quantity of the light-emitting unit 2 is two, which are respectively disposed on left and right of the OFN sensor 1, and preferably the light-emitting unit 2 and the corresponding side of the OFN sensor 1 are spaced at a distance of 5 mm. In a third embodiment shown in FIG. 3, the light-emitting unit 2 is a rectangular frame surrounding the rectangular OFN sensor 1. In a third embodiment shown in FIG. 4, the quantity of the light-emitting unit 2 is two, which are respectively disposed on left and right of the rectangular OFN sensor 1, and preferably the light-emitting unit 2 and the corresponding side of the OFN sensor 1 are spaced at a distance of 5 mm. There are many similar examples, so not listed here.

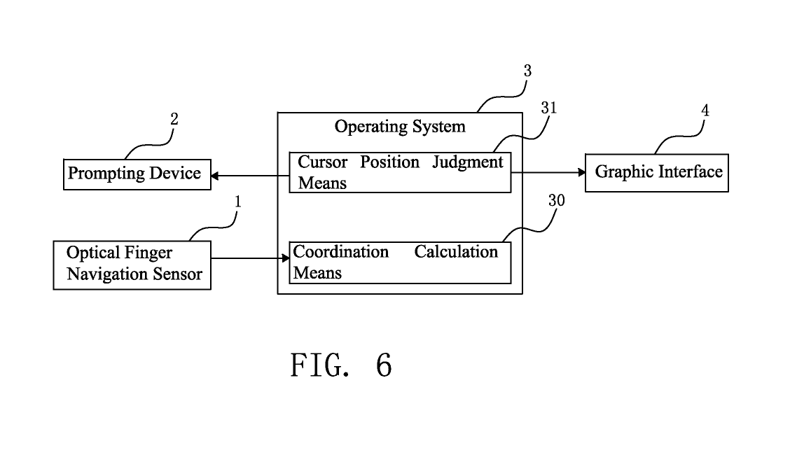

Please refer to FIG. 6, the prompting device (i.e., the light-emitting units 2) of the present invention is integrated with the OFN sensor 1. The electrical device adopted the prompting device 2 and the OFN sensor 1 has an operating system 3 embedded a coordination calculation means 30 and a cursor position judgment means 31. According to the finger position transmitted back to the operating system 3 from the OFN sensor 1 and the action that the operating system 3 can do next after processed, the light-emitting unit 2 provides a blue or green optical indication for the user to perform the next action. Or when the operation system 3 performs the action needed to prompt, the prompting device can prompt the user for the next action. The finger position is obtained by the OFN sensor 1 transmitting the movement of the finger to the coordination calculation means 30 and the coordination calculation means 30 calculating the movement of the finger to provide a coordination representing the position of the finger. Then the coordination is provided to the cursor position judgment means 31 in order to judge the cursor position. Finally, the cursor position is provided to the graphic interface 4 and the cursor position judgment means 31 can judge whether the cursor position is move to the system button.

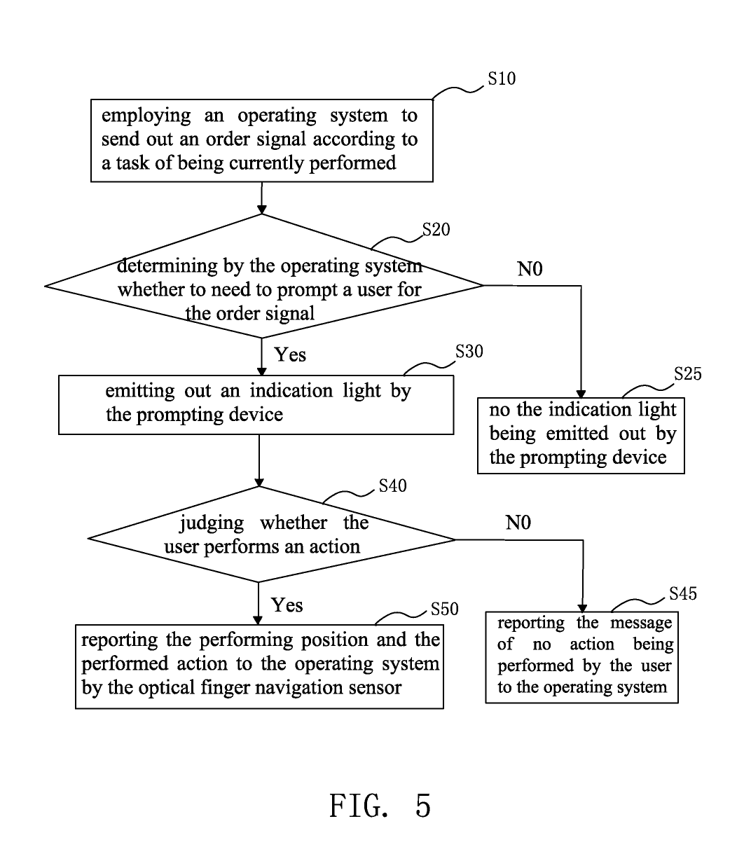

Referring to FIG. 5, which is a prompting method of the prompting device of the OFN sensor 1, the prompting method comprises the following steps of S10 to S50:

The step of S10 is a step of employing the operating system 3 to send out an order signal according to a task of being currently performed. For example, when the user performs the installation process, the user needs to confirm the installation process, such as select a system button of enter or cancel so that the operating system 3 can send out the order signal.

The step of S20 is a step of determining by the operating system 3 whether to need to prompt the user for the order signal, and if it needs to prompt, performing the step of S30.

The step of S30 is a step of emitting out an indication light by the prompting device of the OFN sensor 1 according to the order signal. Namely, according to the order signal, the user can be prompted to perform or confirm each action of this task. Specifically, the light-emitting unit 2 emits out an indication light, such as a continuous green light for prompting the user to confirm. After the completion of performing the step of S30, the step of S40 will be performed.

The step of S40 is a step of judging whether the user performs the action, and if the user performs the action in a predetermined time, then performing a step of S50.

The step of S50 is a step of reporting the performing position and the performed action and transmitting these messages back to the operating system by the OFN sensor 1. For example, in the predetermined time, if the OFN sensor 1 senses that the user has clicked the button about the action, the OFN sensor 1 will report the clicking position and the clicked action to the operating system 3. Accordingly, the operating system 3 can know whether the process needs to continuously proceed or be canceled.

In the step of S20, if the operating system confirms that the user need not be prompted for the order signal, the prompting method will perform a step of S25. The step of S25 is that the prompting device of the OFN sensor 1 does not prompt the user. Namely, no the indication light is emitted out.

In the step of S40, if the OFN sensor 1 does not sense that the user performs the action in the predetermined time, the prompting method will perform a step of S45. The step of S45 is that the OFN sensor 1 reports the message of no action being performed by the user to the operating system 3. For example, in the predetermined time, if the user does not click the enter button, the OFN sensor 1 will report the message of the enter button of not being clicked to the operating system 3.

Please refer to FIG. 6, the present invention also provides a prompting system. The prompting system comprises: the operating system 3 sending out an order signal according to a task of being currently performed and determining whether to need to prompt a user for the order signal; the prompting device 2 emitting out an indication light according to the order signal; and the OFN sensor 1 sensing that the user performs an action, reporting the performing position and the performed action and transmitting these messages back to the operating system 3.

In the prompting system of the present invention, the prompting device 2 will not prompt the user if the operating system 3 ascertains that the user need not be prompted for the order signal.

In the prompting system of the present invention, the OFN sensor 1 will report the message of no action being performed by the user to the operating system 3 if the OFN sensor 1 does not sense that the user performs the action in a predetermined time.

Moreover, when the electrical device, such as the palmtop mobile internet device and so on has an indication of system status or receives the outside information (such as news in brief or push information), it can adopt the prompting device of the OFN sensor 1 to prompt the user.

It can be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A prompting device for an optical finger navigation sensor, comprising:
at least one light-emitting unit, being disposed around the optical finger navigation sensor.

2. The prompting device for an optical finger navigation sensor as claimed in claim 1, wherein the light-emitting unit is annular and surrounds the optical finger navigation sensor.

3. The prompting device for an optical finger navigation sensor as claimed in claim 1, wherein the quantity of the light-emitting unit is two, which are respectively disposed on two sides of the optical finger navigation sensor.

4. The prompting device for an optical finger navigation sensor as claimed in claim 1, wherein the light-emitting unit is a blue light source.

5. The prompting device for an optical finger navigation sensor as claimed in claim 1, wherein the light-emitting unit is a green light source.

6. A prompting method of a prompting device for an optical finger navigation sensor, comprising the following steps of:
1) employing an operating system to send out an order signal according to a task of being currently performed;
2) determining by the operating system whether to need to prompt a user for the order signal, and if need to prompt, performing a step of 3);
3) emitting out an indication light by the prompting device according to the order signal;
4) judging whether the user performs an action, and if the optical finger navigation sensor senses that the user performs the action in a predetermined time, performing a step of 5); and
5) reporting the performing position and the performed action and transmitting these messages back to the operating system by the optical finger navigation sensor.

7. The prompting method as claimed in claim 6, wherein in the step of 2), if the operating system determines that the user need not be prompted for the order signal, the prompting device of the optical finger navigation sensor will not prompt the user.

8. The prompting method as claimed in claim 6, wherein in the step of 4), if the optical finger navigation sensor does not sense that the user performs the action in the predetermined time, the optical finger navigation sensor will report the message of no action being performed by the user to the operating system.

9. A prompting system comprising:
an operating system sending out an order signal according to a task of being currently performed and determining whether to need to prompt a user for the order signal;
a prompting device emitting out an indication light according to the order signal; and
an optical finger navigation sensor sensing that the user performs an action, reporting the performing position and the performed action and transmitting these messages back to the operating system.

10. The prompting system as claimed in claim 9, wherein the prompting device will not prompt the user if the operating system ascertains that the user need not be prompted for the order signal.

11. The prompting system as claimed in claim 10, wherein the optical finger navigation sensor will report the message of no action being performed by the user to the operating system if the optical finger navigation sensor does not sense that the user performs the action in a predetermined time.

12. The prompting system as claimed in claim 9, wherein the prompting device has at least one light-emitting unit being disposed around the optical finger navigation sensor.

13. The prompting system as claimed in claim 12, wherein the light-emitting unit is annular and surrounds the optical finger navigation sensor.

14. The prompting system as claimed in claim 12, wherein the quantity of the light-emitting unit is two, which are respectively disposed on two sides of the optical finger navigation sensor.

15. The prompting system as claimed in claim 12, wherein the light-emitting unit is a blue light source.

16. The prompting system as claimed in claim 12, wherein the light-emitting unit is a green light source.
